(19) United States
(12) Patent Application Publication
(10) Pub. No.: US 2015/0242004 A1
(43) Pub. Date: Aug. 27, 2015

(54) TOUCH-SENSITIVE INPUT DEVICE HAVING A LOGO DISPLAYED THEREON FOR USE IN A MOBILE ELECTRONIC DEVICE

(71) Applicant: Sony Corporation, Tokyo (JP)

(72) Inventors: Michael Chang, San Diego, CA (US); Jesse Gallup, San Marcos, CA (US)

(21) Appl. No.: 14/188,873

(22) Filed: Feb. 25, 2014

(51) Int. Cl. G06F 3/041

(52) U.S. Cl. CPC G06F 3/041

(57) ABSTRACT

An electronic device includes a housing and a processor disposed within the housing. The electronic device also includes a touch-sensitive input device lacking output functionality. The touch-sensitive input device, which is located on a surface of the housing, is operatively associated with the processor for triggering a function of the electronic device and being located on a surface of the housing. A visible logo is disposed on the touch-sensitive input device.

### BACKGROUND

Mobile electronic devices such as mobile computers (PCs), mobile telephones and so forth generally carry some badge or printed information on their casing to identify the brand of the supplier. The aesthetic design of such items, as distinct from their functionality or price, is increasingly a factor in purchasing decisions of buyers, as these items become commodity items. Suppliers are keen to use their products as a platform for promoting their brand, so a prominent and attractive badge is often desirable.

One problem with the use of logos or the like on a mobile electronic device is that they occupy valuable space that could otherwise be used for other purposes, such as to locate physical buttons, for example. As the form factors for mobile electronic devices become smaller, the amount of space available for physical buttons or other functional elements is reduced. Accordingly, the space occupied by a logo is becoming even more valuable.

### SUMMARY

In accordance with one aspect of the invention, a mobile electronic device such as a smartphone or the like makes efficient use of the limited space available on such devices by transforming a non-functional element appearing on the device such as logo into a functional element. In particular, in one implementation, the logo may be configured to function as a user input device that can be used to perform any of a wide variety of different tasks. For example, in some cases the logo may serve as a power or ON button, a launch button (e.g., to launch an application), and so on.

In one particular implementation the user input device is a touch-sensitive sensor that is responsive to a single contact or, additionally, to multiple contacts such as gestures.

### BRIEF DESCRIPTION OF THE DRAWINGS

FIG. 1 is a plan view of one example of a mobile electronic device.

FIG. 2 shows a cross-sectional view through the touch-screen display.

FIG. 3 is a plan view of another example of a mobile electronic device.

FIG. 4 shows one example of a touch-sensitive sensor or input device.

FIG. 5 shows another example of a touch-sensitive sensor or input device that employs a sensor panel and controller.

FIG. 6 shows the high level architecture of one example of a mobile electronic device such as the device shown in FIG. 1.

### DETAILED DESCRIPTION

The subject matter disclosed herein is generally applicable to a mobile or portable electronic device. Examples of applicable mobile electronic devices may include, without limitation, cellular phones, smart-phones, tablet computers, wireless organizers, personal digital assistants, computers, laptops, handheld wireless communication devices, wirelessly enabled notebook computers, portable gaming devices, and the like. Such devices will hereinafter be commonly referred to as “mobile electronic devices” for the sake of clarity. It will however be appreciated that the principles described herein are also suitable to other electronic devices, e.g. “non-mobile” devices. For example, the principles herein are equally applicable to personal computers (PCs), tabletop computing devices, wall-mounted screens such as kiosks, or any other computing device.

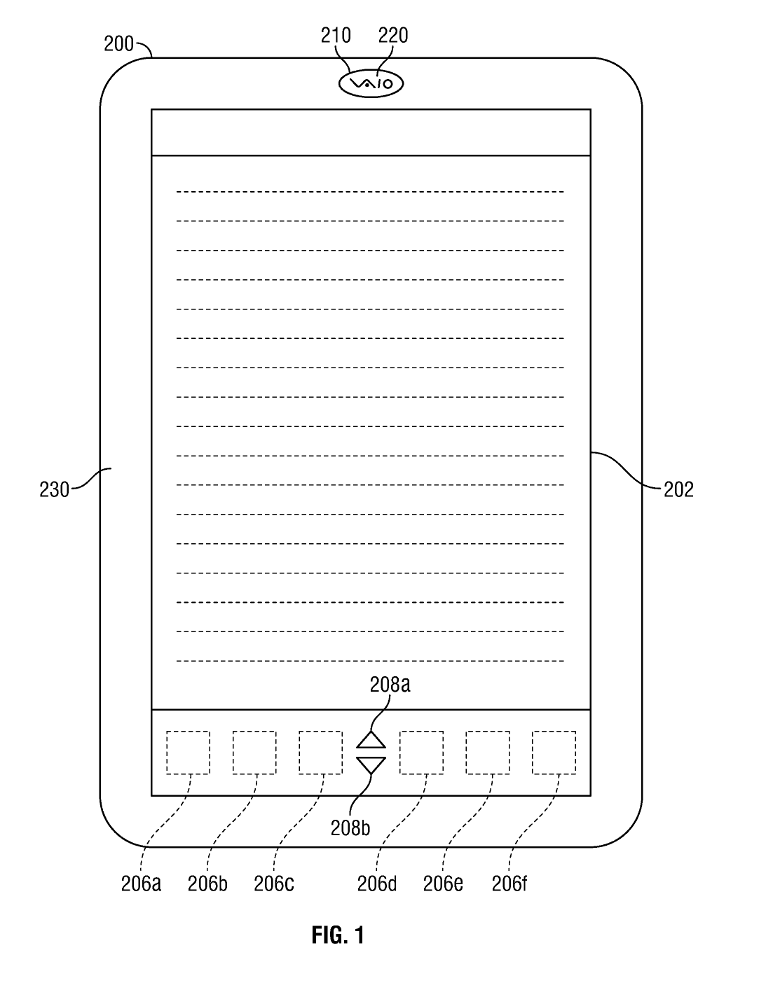

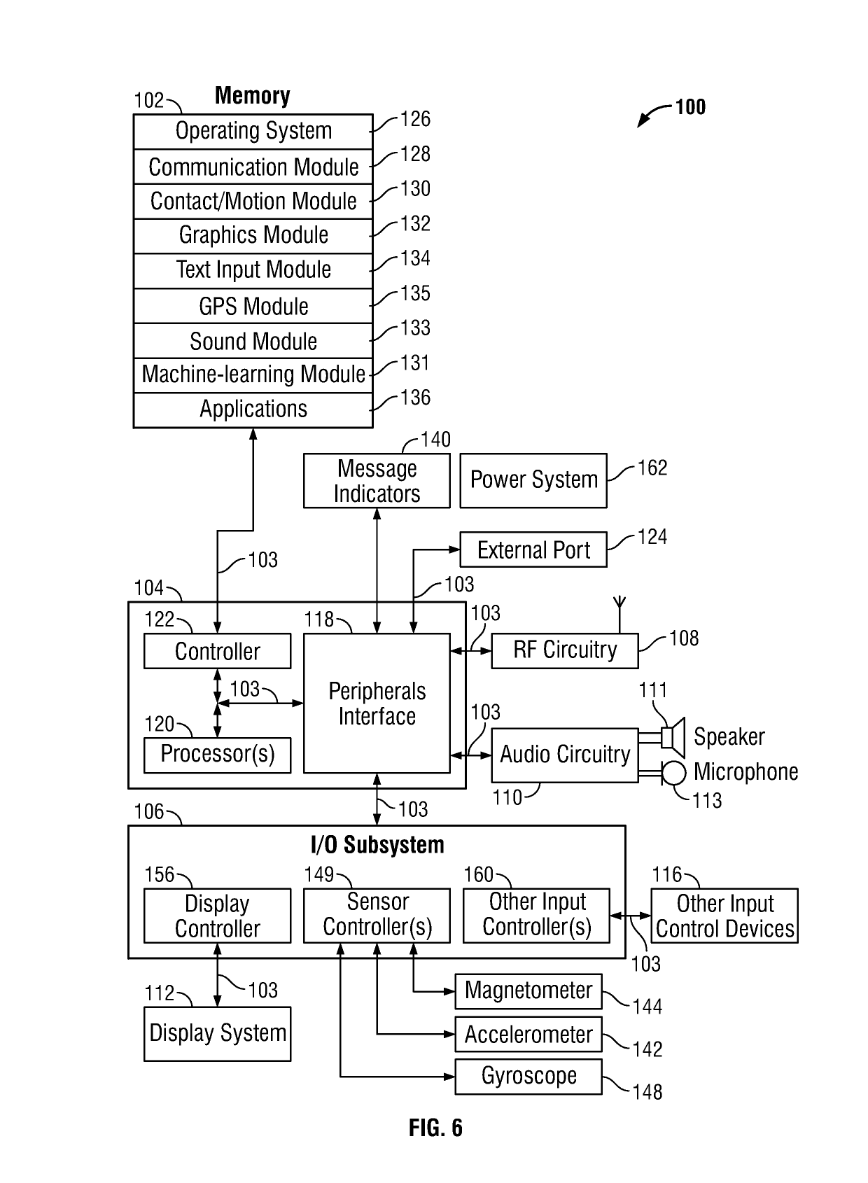

FIG. 1 is a plan view of one example of a mobile electronic device 200. In this particular example the mobile electronic device is configured as a tablet. The tablet 200 includes a housing 230 that encloses components such as those shown in FIG. 6. The housing 230 may include a back, sidewalls and a front that frames a touch-screen display 202. The touch-screen display 202 serves as both an input device and an output device. When operating as output device, tablet 200 displays data on a screen such as a liquid crystal display (LCD) screen. Touch-screen display 202 also includes a thin layer of sensing circuitry present either beneath the screen or as part of a thin, clear membrane overlying the screen that is sensitive to the position of a finger, pen or other stylus on its surface. The sensing circuitry provides the touch-sensitive input functionality of the touch-screen display 202.

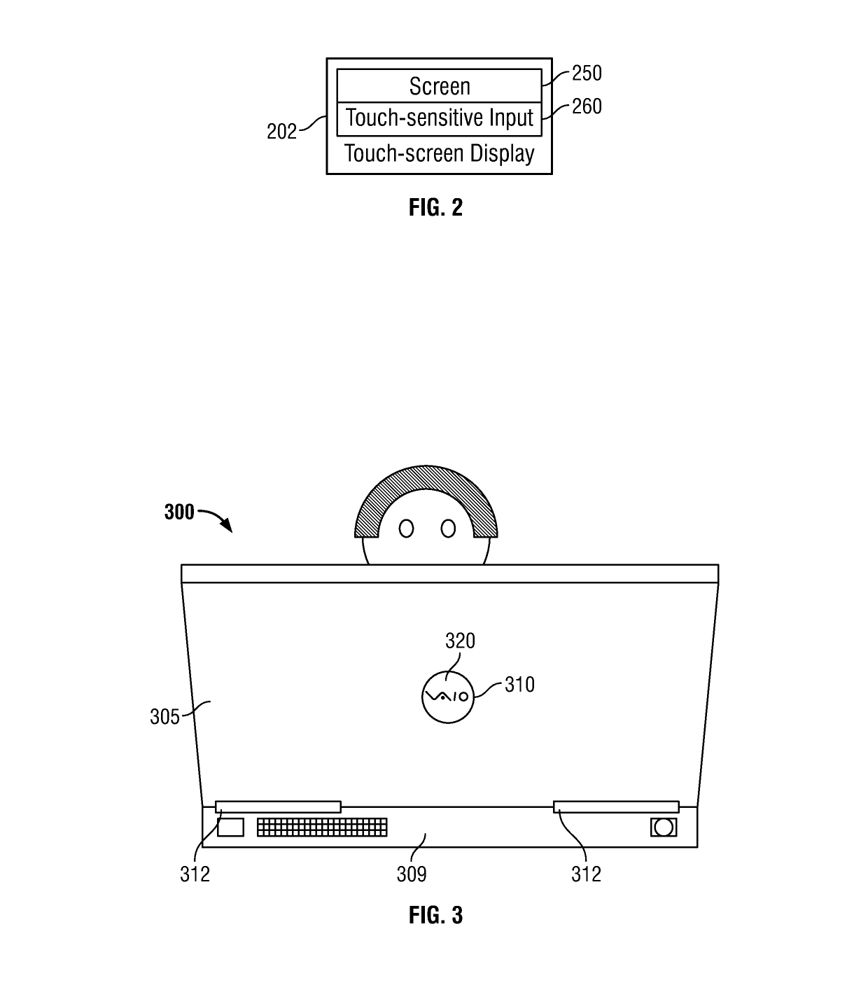

FIG. 2 shows a cross-sectional view through the touch-screen display 202. As shown, in this example screen 250, which provides output functionality, overlies a touch-sensitive sensor 260, which provides input functionality.

Referring again to FIG. 1, an array of virtual input buttons 206a-f may be displayed by the screen portion of the touch-screen display 202. By tapping the virtual buttons 206a-f with a stylus so that an input is received by the touch-sensitive sensor portion of the touch-screen display 202, the user may cause various commands to be carried out by the tablet 118. Up and down virtual scroll buttons 208a and 208b, which can be similarly activated by the pen 220, may also be provided.

The mobile electronic device shown in FIG. 1 also includes a badge or logo 220 that is applied to the front surface of the housing 230. The logo 220 in this example presents (for the sake of illustration) a stylized symbol that is associated with and used to identify the manufacturer of the mobile electronic device 200. More generally, the logo 220 may be a graphic mark emblem, symbol or other design (possibly including text) that is adopted by an organization or individual to identify that organization or individual, a product or service, or a brand associated with the organization or individual.

In this example the logo 220 is located on the same surface of the housing 230 as the touch-screen display 202. Of course the logo 220 may be located on any desired portion of the housing 230. For example, in FIG. 3 the mobile electronic device is illustrated as a laptop computer 300 having a base 309 which houses the keyboard, battery and electronics and a lid 305 housing a display screen (not shown). These portions 305 and 309 are coupled by a hinge 312, so that the lid 305 can be closed against the base for compactness and protection of the screen, or opened up for viewing at a desired angle.

As shown, a logo 320 is located on the lid 305 of the laptop computer 300. In other embodiments the logo 320 may be located on the same surface of the laptop computer 300 as the keyboard (not shown). Of course, the location of the logo(s) is not limited to the examples shown herein.

The logos shown in FIGS. 1 and 3 may be formed on the mobile electronic device housing in any suitable manner. For example, in some cases a screen printing or any other manufacturing process may be employed. The logo also can be assembled from discrete components as an alternative to using screen printing. Direct writing processes (for example by laser) can also be used.

As described above, logos and the like are generally non-functional elements that occupy valuable real estate on mobile electronic devices, particular as their form-factors become smaller and smaller and the number of functions which the mobile electronic device provides increases. In order to make more efficient use of this real estate, the logo described herein is equipped with a function that provides it with a purpose above and beyond its conventional purely non-functional role as a design element. In particular, the logo may be configured to function as a user input device that can be used to perform any of a wide variety of different tasks. For example, in some cases the logo may serve as a power or ON button, a launch button (e.g., to launch an application), and so on.

In order to impart the logo with user input functionality, a touch-sensitive sensor may be employed on which the logo is formed. In some implementations the touch-sensitive sensor may be similar to the touch-sensitive sensor employed in the touch-screen display 202 shown in FIGS. 1 and 2.

The touch-sensitive sensor (e.g., sensor 210 in FIG. 1) on which the logo (e.g., logo 220 in FIG. 1) is formed may employ any of a wide range of different technologies. For example, some touch-sensitive sensors work by reacting to a change in capacitance, change in resistance or change in inductance effected by a finger or stylus of a user touching the sensor surface. The position sensing capability can be achieved by providing two layers with capacitive or resistive components or elements in the touch sensors. These components are connected with each other horizontally in the first layer and vertically in the second layer to provide a matrix structure enabling to sense a position in x, y-coordinates of where the touch sensor is touched. In capacitive touch sensors, a capacitive component of one layer forms one electrode of a capacitor and the finger or stylus, which has to be conductive, forms another electrode.

Other technologies that may be employed by the touch-sensitive sensor include, without limitation, infrared, surface acoustic wave (SAW), strain gauge, optical imaging, dispersive signal technology, acoustic pulse recognition, and so forth, as known in the art.

In some implementations the touch-sensitive sensor may be a multi-touch sensor that detects or senses two or more simultaneous touching positions at different locations on its surface. In one example the multi-touch sensor can be used to detect gestures that are used to control (e.g., operate a menu, trigger various functions) the mobile electronic device.

A wide range of different gestures may be detected by the mobile-touch sensor. By way of example, the gestures may be single point or multipoint gestures; static or dynamic gestures; continuous or segmented gestures; and/or the like. Single point gestures are those gestures that are performed with a single contact point, e.g., the gesture is performed with a single touch as for example from a single finger, a palm or a stylus. Multipoint gestures are those gestures that can be performed with multiple points, e.g., the gesture is performed with multiple touches as for example from multiple fingers, fingers and palms, a finger and a stylus, multiple styli and/or any combination thereof. Static gestures are those gestures that do not include motion, and dynamic gestures are those gestures that do include motion. Continuous gestures are those gestures that are performed in a single stroke, and segmented gestures are those gestures that are performed in a sequence of distinct steps or strokes. Examples of dynamic gestures include scrub and fling. An example of a static gesture is a click that is used to perform an action such as making a selection, e.g., selecting an item from a list, or accepting an item.

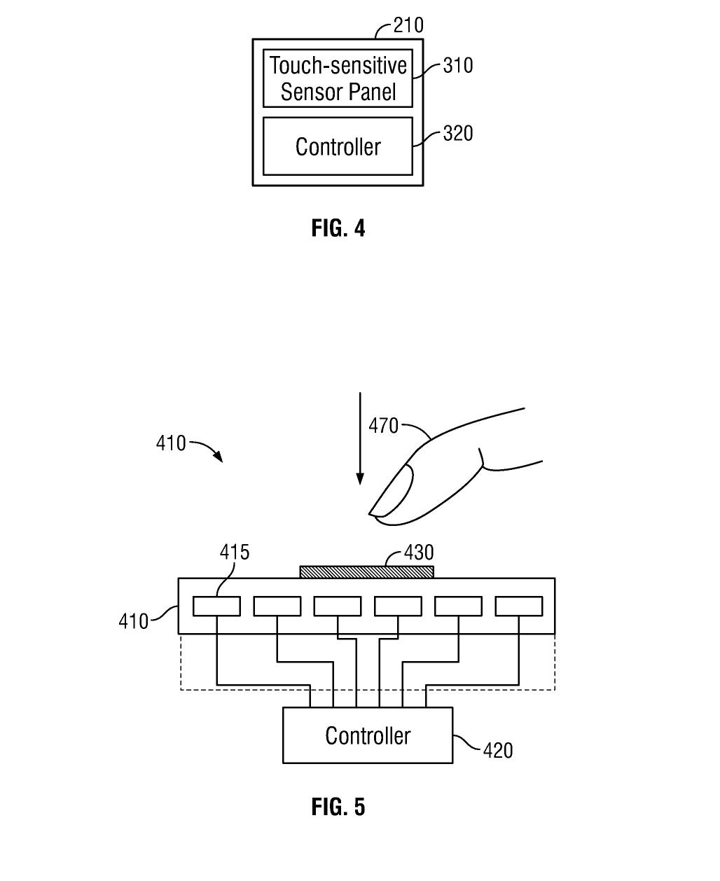

FIG. 4 shows one example of a touch-sensitive sensor or input device 210 that may be employed by the mobile electronic devices described herein. The touch-sensitive sensor 210 includes a touch-sensitive sensor panel 310 and a controller 320. The touch-sensitive sensor panel 310 is operable to sense a region of the panel that is touched by the user.

It should be understood that touching a region of the sensor panel 310 does not necessarily require pressing a finger or other stylus against the panel, since in capacitive sensing, for example, a touch can be sensed by the mere presence of a finger or stylus above the sensor panel 310. In other words, in capacitive sensing it may not be necessary that the sensor panel is actually touched in the meaning of contacting the sensor panel since the stylus may float over the sensor panel with a spacing of 1 mm, for example.

The controller 320 is adapted to determine a position of the touched region on the sensor panel 310 at different times. In some implementations the controller 320 may also determine the shape of the region on the sensor panel that is touched. Accordingly, additional information is obtained which indicates how the user is touching the sensor panel 310. For example, the controller may determine the shape and position of the touched region every 0.2 seconds. In this way movement of a stylus on the sensor panel 310 can be tracked.

Further, the controller 320 is adapted to trigger a function of the mobile electronic device dependent on the change in position and possibly shape of the touched region with time. That is, the controller is able to trigger functions in response to gestures that are received.

A more specific example of a touch-sensitive input device including the sensor panel 110 and the controller as well as operations thereof is described with respect to FIG. 5. The touch-sensitive input device 410 of FIG. 5 comprises controller 420 and capacitive sensor panel 410. Also shown in FIG. 4 is the logo 430 disposed over the sensor panel 110.

The sensor panel 410 has a plurality of touch-sensitive elements 415 activatable by the user, wherein the activated elements define the touched region of the sensor panel. As known in the art, touch-sensitive elements may constitute a matrix structure, for example an x, y-array forming a grid pattern of electrode elements for capacitive sensing. Electrode elements may be conductors that each form an electrode of a capacitor. Charge is supplied to the electrode element resulting in an electrostatic field, wherein the electric properties are changed when a finger or the like, e.g. finger 470, provides for a second conductive electrode as a counterpart to form a capacitor. Accordingly, a change in capacitance, i.e. in the electrostatic field, can be measured so that the finger 470 above the electrode element can be detected.

FIG. 6 shows the high level architecture of one example of a mobile electronic device 100 such as the device shown in FIG. 1. The mobile electronic device 100 may be a mobile communications device such as a wireless phone that also contains other functions, such as PDA and/or music player functions. To that end the device may support any of a variety of applications, such as a telephone application, a video conferencing application, an e-mail application, an instant messaging application, a blogging application, a digital camera application, a digital video camera application, a web browsing application, a digital music player application, and/or a digital video player application. It may also support applications that make use of data concerning the spatial orientation of the device, including but not limited to augmented reality applications and the like. While the example in FIG. 6 is depicted as a mobile communications device, the computing device more generally may by any of a wide variety of different devices such as a laptop computer, a tablet computer, a smart phone and a netbook, for example.

The device 100 includes a memory unit 102 (which may include one or more computer readable storage media), a memory controller 122, one or more processors (CPU's) 120, a peripherals interface 118, RF circuitry 108, audio circuitry 110, a speaker 111, a microphone 113, display system 103, an input/output (I/O) subsystem 106, other input or control devices 116, and an external port 124. These components may communicate over one or more communication buses or signal lines. Along with the input or control devices 116, the speaker 111, microphone 113 and display system 103 form a user interface through which a user can enter and receive various types of information and can communicate with other individuals over communication networks using RF circuitry 108.

Memory unit 102 may include high-speed random access memory and non-volatile memory, such as one or more magnetic disk storage devices, flash memory devices, or other non-volatile solid-state memory devices. Access to memory unit 102 by other components of the device 100, such as the processor 120 and the peripherals interface 118, may be controlled by the memory controller 122. The peripherals interface 118 couples the input and output peripherals of the device to the processor 120 and memory unit 102. The one or more processors 120 run or execute various software programs and/or sets of instructions stored in memory unit 102 to perform various functions for the device 100 and to process data. In some examples the peripherals interface 118, the processor 120, and the memory controller 122 may be implemented on a single chip, such as a chip 104. In other examples they may be implemented on separate chips.

The RF (radio frequency) circuitry 108 includes a receiver and transmitter (e.g., a transceiver) for respectively receiving and sending RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 110, the speaker 111, and the microphone 113 form a part of the user interface to provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from audible signals (i.e., sound waves). The speaker 111 and microphone 113 are two examples of audio transducers that may be employed in the mobile communications device. The audio circuitry 110 converts the electrical signal to audio data and transmits the audio data to the peripherals interface 118 for processing.

Audio data may be retrieved from and/or transmitted to memory unit 102 and/or the RF circuitry 108 by the peripherals interface 118. In some embodiments, the audio circuitry 110 also includes a headset jack (not shown). The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the display screen 112, sensor controller 149 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some examples input controller(s) 160 may be coupled to any (or none) of the following: a keyboard, infrared port, USB port, and a pointer device such as a mouse.

The display screen 112 provides an input interface and an output interface between the device and a user. The display controller 156 receives and/or sends electrical signals from/to the display screen 112. The display screen 112 displays visual output to the user. The visual output may include graphics, text, icons, video, and any combination thereof (collectively termed “graphics”).

The display screen 112 will generally include a suitable display such as an OLED display, PLED display, active matrix liquid crystal display, passive matrix liquid crystal display, electrophoretic display, cholesteric liquid crystal display, polymer dispersed liquid crystal and nematic liquid crystal display. In some implementations the display screen 112 may be a touch-screen display.

The device 100 also includes one or more environmental sensors, which are in communication with peripherals interface 118 via sensor controllers 149. Such sensors may be used to capture the value of various environmental parameters and in this example, include two inertial sensors (a gyroscope 148 and accelerometer 142) and an optional magnetometer 144.

The device 100 also includes a power system 162 for powering the various components. The power system 162 may include a portable power supply (e.g., battery) and components used to receive power from an alternating current (AC) source, a power management system, a recharging system, a power failure detection circuit, a power converter or inverter and any other components associated with the generation, management and distribution of power in portable devices.

In some embodiments, the software components stored in memory unit 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, a sound module 133 (or set of instructions) and applications (or set of instructions) 136.

The operating system 126 (e.g., Darwin, RTXC, LINUX, UNIX, OS X, Microsoft WINDOWS®, Android or an embedded operating system such as VxWorks) includes various software components and/or drivers for controlling and managing general system tasks (e.g., memory management, storage device control, power management, etc.) and facilitates communication between various hardware and software components. The communication module (or set of instructions) 128 facilitates communication with other devices over one or more external ports 124 and also includes various software components for handling data received by the RF circuitry 108 and/or the external port 124 (e.g., Universal Serial Bus (USB), FIREWIRE, etc.).

The graphics module 132 includes various known software components for rendering and displaying graphics on the display screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. The text input module (or set of instructions) 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and may provide this information for use in various applications (e.g., applications that provide location-based services such as weather widgets, local yellow page widgets, and map/navigation widgets).

The applications 138 may include any combination of the following illustrative modules: a contacts module, a telephone module; a video conferencing module; an e-mail client module an instant messaging (IM) module; a blogging module; a camera module; an image management module; a video player module; a music player module; a browser module; a word processing module; a voice recognition module; a calendar module; widget modules, which may include a weather widget, stocks widget, calculator widget, alarm clock widget, dictionary widget, and other widgets obtained by the user, as well as user-created widgets. As described above, one or more of the applications may also employ spatial orientation data.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory unit 102 may store a subset of the modules and data structures identified above. Furthermore, memory unit 102 may store additional modules and data structures not described above.

It should be appreciated that the device 100 is only one example of a mobile communications device 100 and that the device 100 may have more or fewer components than shown, may combine two or more components, or a may have a different configuration or arrangement of components. The various components shown in FIG. 6 may be implemented in hardware, software or a combination of hardware and software, including one or more signal processing and/or application specific integrated circuits.

It should be noted that the touch-sensitive input device described herein may be used with a wide variety of portable (and non-portable) electronic devices in addition to those mentioned above. For example, the touch-sensitive input device can be used on electronic key fobs, such as those used as remote keyless entry systems for motor vehicles, building entrances as the like. In the case of motor vehicles, for example, the logo is located on the touch-sensitive input device may be the logo of the vehicle manufacturer, which is typically prominently displayed on such key fobs.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a SIM card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. An electronic device, comprising:
a housing;
a processor disposed within the housing;
a touch-sensitive input device lacking output functionality, the touch-sensitive input device being operatively associated with the processor for triggering a function of the electronic device and being located on a surface of the housing; and
a visible logo disposed on the touch-sensitive input device.

2. The electronic device of claim 1, wherein the touch-sensitive input device includes a plurality of resistive touch-sensitive elements.

3. The electronic device of claim 1, wherein the touch-sensitive input device includes a plurality of capacitive touch-sensitive elements.

4. The electronic device of claim 1, wherein the electronic device is mobile communications device.

5. The electronic device of claim 1, wherein the electronic device is selected from the group consisting of a smartphone and tablet.

6. The electronic device of claim 1, wherein the touch-sensitive input device is a multi-touch sensor for detecting gestures.

7. The electronic device of claim 1, wherein the touch-sensitive input device is a multi-touch sensor for detecting static gestures.

8. The electronic device of claim 1, wherein the function triggered by the touch-sensitive input device includes a power on function.

9. The electronic device of claim 1, wherein the touch-sensitive input device triggers launch of an application.

10. The electronic device of claim 1, wherein the visible logo is a screen printed logo.

11. The electronic device of claim 1, wherein the visible logo is formed by a direct writing process.

12. The electronic device of claim 1, further comprising an output display located on the housing.

13. The electronic device of claim 12, wherein the output display includes a touch-screen display providing both input and output functionality.

14. A touch-sensitive input device for an electronic device, comprising
a touch-sensitive sensor panel operable to sense a region of said touch-sensitive sensor panel that is touched by a user;
a controller adapted to determine at least a position of the touched region on said touch-sensitive sensor panel at different times and, responsive thereto, execute an action on the electronic device; and
a visible logo disposed over the touch-sensitive sensor panel.

15. The touch-sensitive input device of claim 1, wherein the touch-sensitive sensor panel includes a plurality of resistive touch-sensitive elements.

16. The touch-sensitive input device of claim 1, wherein the touch-sensitive sensor panel includes a plurality of capacitive touch-sensitive elements.

17. The touch-sensitive input device of claim 1, wherein the controller is further adapted to execute an action in response to gestures received by the touch-sensitive sensor panel.

18. The touch-sensitive input device of claim 1, wherein the controller triggers launch of an application on the electronic device.

19. The touch-sensitive input device of claim 1, wherein the visible logo is a screen printed logo.

20. The touch-sensitive input device of claim 1, wherein the visible logo is formed by a direct writing process.
